(19) United States
(12) Patent Application Publication
(10) Pub. No.: US 2009/0021861 A1
(43) Pub. Date: Jan. 22, 2009

(54) Magnetic write device including an encapsulated wire for assisted writing

(75) Inventors: Vladyslav A. Vas'ko, Apple Valley, MN (US); Mark T. Kief, Lakeville, MN (US); Prabath S. Perera, Eagan, MN (US); Aly A. Bazama, Bloomington, MN (US)

Correspondence Address: KINNEY & LANGE, P.A., 312 SOUTH 3RD STREET, THE KINNEY & LANGE BUILDING, MINNEAPOLIS, MN, 55415, US

(73) Assignee: Seagate Technology LLC, Scotts Valley, CA (US)

(21) Appl. No.: 11/879,075

(22) Filed: Jul. 16, 2007

(51) Int. Cl. G11B 5/187; G11B 5/147

(52) U.S. Cl. 360/122; 977/947; G9B/5.051

(57) ABSTRACT

A magnetic device includes a write element having a write element tip and is operable to generate a first field at the write element tip. A conductor is proximate the write element tip for carrying a current to generate a second field that augments the first field. An encapsulating layer is on at least one surface of the conductor, wherein the encapsulating layer is made of a material that increases a maximum sustainable current density of the conductor to greater than about 10⁸ A/cm².

### BACKGROUND

As magnetic recording storage densities continue to progress in an effort to increase the storage capacity of magnetic storage devices, magnetic transition (i.e., bit) dimensions and critical features of the recording device are being pushed below 100 nm. In some cases, the critical dimensions of the write element are decreasing faster than the spacing between the write element and the magnetic medium. This presents a significant challenge in that not only is the magnetic field strength effectively reduced, but the magnetic field profile at the medium is more poorly confined. The result is that off-track fields can cause undesirable effects such as adjacent track or side track erasure. Thus, an important design consideration is to confine the magnetic fields more effectively without significantly degrading the field strength at the medium.

In addition, in order to make the recording medium stable at higher areal densities, magnetically harder (i.e., high coercivity) storage medium materials are used. A magnetically harder medium may be written to by increasing the saturation magnetization value of the magnetic material of the recording device to increase the magnetic field applied to the magnetic medium. However, the rate of increase of the saturation magnetization value is not sufficient to sustain the annual growth rate of bit areal densities. In order to provide a stronger write field to write to the magnetically hard medium, a device, such as a current-carrying conductor, may be incorporated adjacent to the tip of the write pole that produces an assisting magnetic field that reduces the coercivity of the magnetic medium near the write pole. This allows data to be written to the high coercivity medium with a lower magnetic field from the write pole. However, current densities higher than those producible by conventional write assist devices are needed to generate an assist magnetic field large enough to overcome the coercivity of the magnetic medium.

### SUMMARY

The present invention relates to a magnetic device including a write element having a write element tip. The write element is operable to generate a first field at the write element tip. A conductor is proximate the write element tip for carrying a current to generate a second field that augments the first field. An encapsulating layer is on at least one surface of the conductor, wherein the encapsulating layer is made of a material that increases a maximum sustainable current density of the conductor to greater than about 10⁸ A/cm². These and various other features and advantages will be apparent from a reading of the following detailed description.

### BRIEF DESCRIPTION OF THE DRAWINGS

FIG. 1 is a cross-section view of a magnetic writer including an encapsulated write assist conductor proximate a trailing side of the write pole and including an encapsulating layer.

FIG. 2 is a medium confronting surface view of portions of the magnetic writer shown in FIG. 1 including the write pole tip, the write assist conductor, and an encapsulating layer on the write assist conductor.

FIGS. 3A-3F are cross-section views of various configurations the write assist conductor including the encapsulating layer.

FIGS. 4A-4C are graphs of the resistivity versus temperature of various embodiments of the write assist conductor including an encapsulating layer.

### DETAILED DESCRIPTION

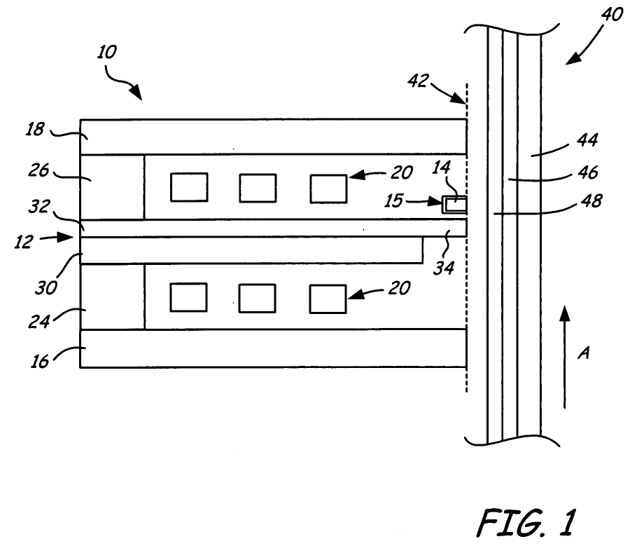

FIG. 1 is a cross-section view of magnetic writer 10, which includes write pole or element 12, current carrying conductor 14 with encapsulating layer 15, first return pole or element 16, second return pole or element 18, and conductive coil 20. Encapsulating layer 15 is shown on three surfaces of conductor 14. Write pole 12 is magnetically coupled to first return pole 16 by first magnetic stud 24, and to second return pole 18 by second magnetic stud 26. Conductive coil 20 surrounds write pole 12 such that portions of conductive coil 20 are disposed between write pole 12 and first return pole 16, and between write pole 12 and second return pole 18. Write pole 12 includes yoke 30 and write pole body 32 having write pole tip 34.

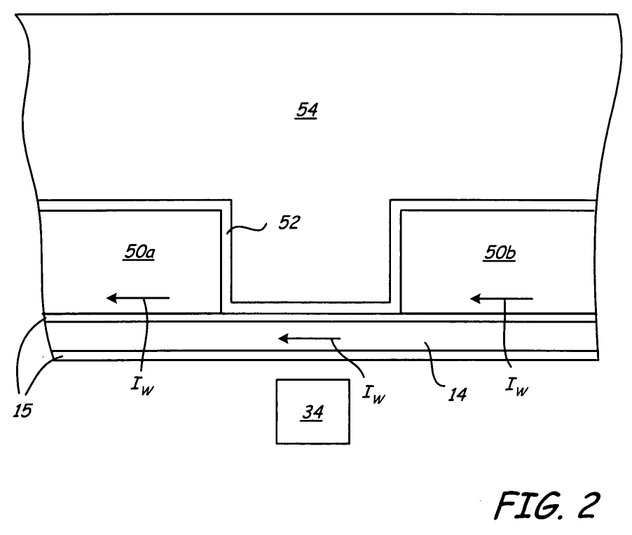

FIG. 2 is a medium confronting surface view of portions of magnetic writer 10, including write pole tip 34 and conductor 14 with encapsulating layer 15. Conductor 14 is positioned along the medium confronting surface adjacent to the trailing edge of write pole tip 34. First electrical contact 50a and second electrical contact 50b overlay portions of conductor 14 and encapsulating layer 15 that extend beyond the edges of write pole tip 34. The overlaid surfaces of electrical contacts 50a and 50b are much larger than the cross-section of conductor 14. In an alternative embodiment, first electrical contact 50a is electrically connected to one end of conductor 14 and second electrical contact 50b is electrically connected to an opposite end of conductor 14. Electrical contacts 50a and 50b are coupled to a current source (not shown), which provides a wire current I_{W} that flows through electrical contacts 50a and 50b and conductor 14. Heat sink 54, which is separated from encapsulating layer 15 and electrical contacts 50a and 50b by insulating material 52, may be provided to allow for heat transfer across insulating material 52.

Conductor 14 may be comprised of a material having low electrical resistivity that is moderately to highly corrosion resistive, such as Au, Cu, or Ag. First return pole 16, second return pole 18, first magnetic stud 24, and second magnetic stud 26 may be comprised of soft magnetic materials, such as NiFe, CoNiFe, or CoFe. Conductive coil 20 may be comprised a material with low electrical resistance, such as Cu. Write pole body 32 may be comprised a high moment soft magnetic material, such as CoFe, and yoke 34 and shield 36 may be comprised a soft magnetic material, such as NiFe, CoNiFe, or CoFe, to improve the efficiency of flux delivery to write pole body 32.

Magnetic writer 10 confronts magnetic medium 40 at medium confronting surface 42 defined by write pole tip 34, conductor 14, first return pole 16, and second return pole 18. Magnetic medium 40 includes substrate 44, soft underlayer (SUL) 46, and medium layer 48. SUL 46 is disposed between substrate 44 and medium layer 48. Magnetic medium 40 is positioned proximate to magnetic writer 10 such that the surface of medium layer 48 opposite SUL 46 faces write pole 12. Magnetic medium 40 is shown merely for purposes of illustration, and may be any type of medium usable in conjunction with magnetic writer 10, such as composite media, continuous/granular coupled (CGC) media, discrete track media, or bit-patterned media.

Magnetic writer 10 is carried over the surface of magnetic medium 40, which is moved relative to magnetic writer 10 as indicated by arrow A such that write pole 12 trails first return pole 16, leads second return pole 18, and is used to physically write data to magnetic medium 40. In order to write data to magnetic medium 40, a current is caused to flow through conductive coil 20. The magnetomotive force in conductive coil 20 causes magnetic flux to travel from write pole tip 34 perpendicularly through medium layer 48, across SUL 46, and through first return pole 16 and first magnetic stud 24 to provide a first closed magnetic flux path. The direction of the write field at the medium confronting surface of write pole tip 34, which is related to the state of the data written to magnetic medium 40, is controllable based on the direction that the first current flows through first conductive coil 20.

Stray magnetic fields from outside sources, such as a voice coil motor associated with actuation of magnetic writer 10 relative to magnetic medium 40, may enter SUL 46. Due to the closed magnetic path between write pole 12 and first return pole 16, these stray fields may be drawn into magnetic writer 10 by first return pole 16. In order to reduce or eliminate these stray fields, second return pole 18 is connected to write pole 12 via second magnetic stud 26 to provide a flux path for the stray magnetic fields. The stray fields enter first return pole 16, travel through first magnetic stud 24 and second magnetic stud 26, and exit magnetic writer 10 via second return pole 18.

Magnetic writer 10 is shown merely for purposes of illustrating an example construction that may be used in conjunction with the principles of the present invention, and variations on this design may be made. For example, while write pole 12 includes write pole body 32 and yoke 30, write pole 12 may also be comprised of a single layer of magnetic material. In addition, a single trailing return pole 18 may be provided instead of the shown dual return pole writer configuration. Furthermore, a shield may be formed to extend from the trailing return pole toward write pole 12 proximate the medium confronting surface in a “trailing shield” magnetic writer design.

To write data to high coercivity medium layer 48, a stronger write field may be provided to induce magnetization reversal in magnetic medium 40. To accomplish this, conductor 14 is provided proximate to magnetic medium 40 and the trailing side of write pole tip 34. When current I_{W} is applied to conductor 14, an assist magnetic field is generated that augments the write field produced by write pole 12. Current I_{W} is provided at a high current density through conductor 14. The direction of current I_{W} determines the direction of the assist magnetic field that is generated around conductor 14 pursuant to the right-hand rule. The combination of the write field from write pole 12 and the assist field generated by conductor 14 is employed to overcome the high coercivity of medium layer 48 to permit controlled writing of data to magnetic medium 40. In addition, conductor 14 improves the write field gradient, which provides for a stronger write field proximate to write pole tip 34. While conductor 14 is shown at the trailing side of write pole tip 34, it will be appreciated that conductor 14 may be disposed at other locations proximate write pole tip 34, such as at the leading side of write pole tip 34.

In order to generate an assist magnetic field large enough to overcome the coercivity of magnetic medium 40, encapsulating layer 15 is provided on at least one surface of conductor 14. In the embodiment shown in FIGS. 1 and 2, encapsulating layer 15 is provided on three surfaces of conductor 14. Encapsulating layer 15 is comprised of a material that increases the maximum sustainable current density through conductor 14 (i.e., the current density at which burn-out or material breakdown occurs), which allows conductor 14 to generate an assist magnetic field having a higher magnitude. In some embodiments, encapsulating layer 15 increases the maximum sustainable current density of conductor 14 to greater than about 10⁸ A/cm², encapsulating which is on the order of 100 to 1,000 times the current density of conductor 14 without encapsulating layer 15. By increasing the assist magnetic field generated by conductor 14, the combined write field from write pole 12 and the assist field from conductor 14 more readily overcomes the coercivity of medium layer 48, allowing for better writability to magnetic medium 40.

Encapsulating layer 15 is comprised of a material that provides good adhesion to surrounding materials. In addition, encapsulating layer 15 provides a barrier for interdiffusion between the low resistivity material of conductor 14 with encapsulating layer 15 and other surrounding materials at the elevated temperatures of conductor 14 caused by the high current density of current I_{W} and other surrounding heat sources. Encapsulating layer 15 also inhibits surface diffusion, electromigration, and thermal migration, and provides a thermally stable interface between conductor 14 and surrounding materials by providing a path for dissipation of thermal energy generated by conductor 14 during operation. Furthermore, encapsulating layer 15 provides an additional layer of protection against corrosion around conductor 14.

In some embodiments, encapsulating layer 15 is comprised of a material selected from the group consisting of Ru, Rh, TiW, Ta, NiFeCr, Cr, and combinations and alloys thereof. The material used for encapsulating layer 15 may be selected based on the material used for conductor 14 to minimize interdiffusion between conductor 14 and encapsulating layer 15 (i.e., form a stable interface) and enhance the properties described in the previous paragraph. The following table provides example combinations of materials that may be used for conductor 14 and encapsulating material 15.

| Conductor 14 | Encapsulating layer 15 |
|---|---|
| Au | Ru, Rh, TiW, Ta, or combinations or alloys thereof |
| Cu | Ta, NiFeCr, or combinations or alloys thereof |
| Ag | Cr, Ta, Ru, or combinations or alloys thereof |

Conductor 14 may be formed using different methods to maximize the grain size of the materials to enhance the effect of encapsulating layer 15 on the current density of conductor 14. For example, conductor 14 may be formed using e-beam evaporation, ion beam deposition, sputtering, or other similar processes. In some embodiments, conductor 14 has a down-track thickness in the range of about 5.0 nm to about 1.0 μm, and encapsulating layer 15 has a thickness in the range of about 0.2 nm to about 100 mm.

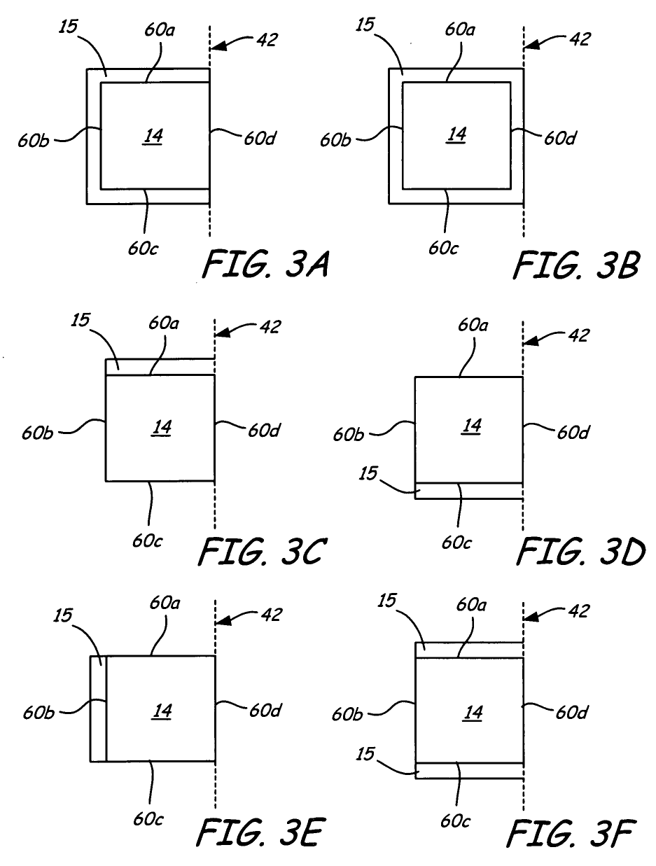

FIGS. 3A-3F are cross-sectional views of conductor 14 including medium confronting surface 42 and having encapsulating layer 15 provided in various configurations on one or more surfaces of conductor 14. Conductor 14 is shown with four surfaces 60a, 60b, 60c, and 60d, but it will be appreciated that conductor 14 may include any number of surfaces on which encapsulating layer 15 may be formed. In the embodiment shown in FIG. 3A, encapsulating layer 15 is provided on surfaces 60a, 60b, and 60c. In the embodiment shown in FIG. 3B, encapsulating layer 15 is formed on surfaces 60a, 60b, 60c, and 60d. In the embodiment shown in FIG. 3C, encapsulating layer 15 is formed on surface 60a. In the embodiment shown in FIG. 3D, encapsulating layer 15 is formed on surface 60c. In the embodiment shown in FIG. 3E, encapsulating layer 15 is formed on surface 60b. In the embodiment shown in FIG. 3F, encapsulating layer 15 is formed on surfaces 60a and 60c. In the embodiments that include encapsulating layer 15 on more than one surface of conductor 14, encapsulating layer 15 may be comprised of the same material on each surface, or different materials may be formed on different surfaces. It will be appreciated that the configurations shown in FIGS. 3A-3F are merely representative of the possible combinations of surfaces 60a-60d on which encapsulating layer 15 may be formed.

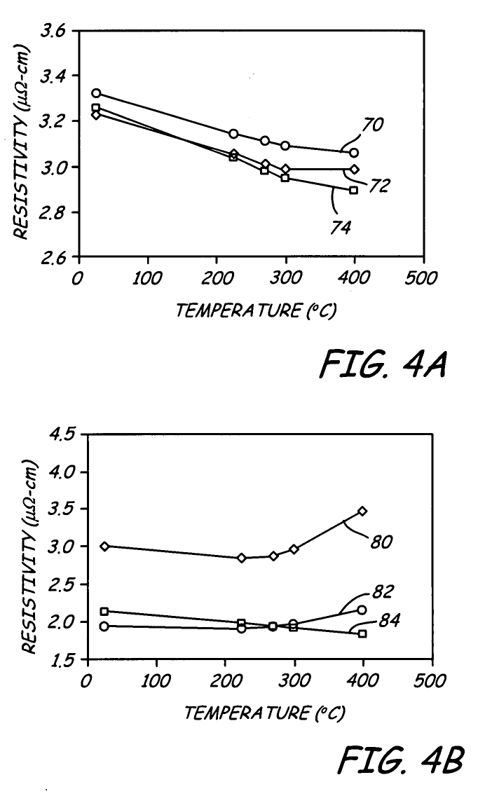

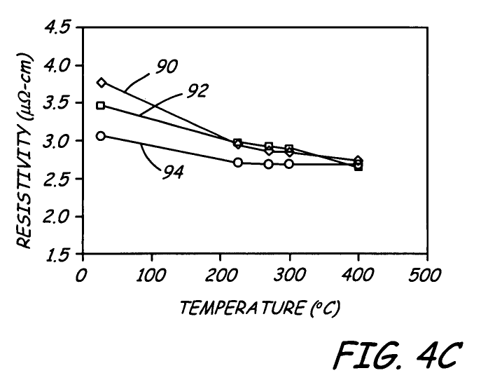

FIGS. 4A-4C are graphs of the resistivity versus applied annealing temperature of various embodiments of conductor 14 including encapsulating layer 15. A significant increase in the resistivity after annealing at elevated temperatures indicates poor stability at the interface of conductor 14 and encapsulating layer 15. Consequently, in order to maintain stability at the elevated operating temperatures associated with high current densities, the resistivity of conductor 14 including encapsulating layer 15 should not increase substantially across the applied temperatures.

The material combinations tested for conductor 14 and encapsulating layer 15 were those provided in the table above, and encapsulating layer 15 was provided on conductor 14 as shown in FIG. 3A. In the write assist devices tested in FIG. 4A, conductor 14 was comprised of Au. Line 70 is a plot of the resistivity of a write assist device including encapsulating layer 15 comprised of TiW, line 72 is a plot of the resistivity of a write assist device including encapsulating layer 15 comprised of Rh, and line 74 is a plot of the resistivity of a write assist device including encapsulating layer 15 comprised of Ru. In each embodiment, the resistivity decreases with increasing applied temperatures.

In FIG. 4B, line 80 is a plot of the resistivity of a write assist device including conductor 14 comprised of Au and encapsulating layer 15 comprised of Ta. Line 82 is a plot of the resistivity of a write assist device including conductor 14 comprised of Cu and encapsulating layer 15 comprised of NiFeCr. Line 84 is a plot of the resistivity of a write assist device including conductor 14 comprised of Cu and encapsulating layer 15 comprised of Ta. In each embodiment, the resistivity does not increase substantially with increasing applied temperatures.

In the write assist devices tested in FIG. 4C, conductor 14 was comprised of Ag. Line 90 is a plot of the resistivity of a write assist device including encapsulating layer 15 comprised of Ru, line 92 is a plot of the resistivity of a write assist device including encapsulating layer 15 comprised of Ta, and line 94 is a plot of the resistivity of a write assist device including encapsulating layer 15 comprised of Cr. In each embodiment, the resistivity decreases and then levels out with increasing applied temperatures.

In summary, the present invention relates to a magnetic device including a write element having a write element tip. The write element is operable to generate a first field at the write element tip. A conductor is proximate the write element tip for carrying a current to generate a second field that augments the first field. An encapsulating layer is on at least one surface of the conductor, wherein the encapsulating layer is made of a material that increases a maximum sustainable current density of the conductor to greater than about 10⁸ A/cm². By increasing the assist magnetic field generated by the conductor, the combined write field from the write element and the assist field from the conductor more readily overcomes the coercivity of the medium layer, allowing for better writability to the magnetic medium.

Although the present invention has been described with reference to preferred embodiments, workers skilled in the art will recognize that changes may be made in form and detail without departing from the spirit and scope of the invention. For example, while encapsulating layer 15 has been described with regard to use in association with write assist conductor 14 in magnetic writer 10, conductor 14 with encapsulating layer 15 may be used in other applications that employ high current densities including, but not limited to, magnetic recording head contacts and interconnects, and microelectromechanical systems (MEMS) devices. In addition, the contacts connecting conductor 14 to a current source may also include an encapsulating layer to improve the reliability of the contacts.

1. A magnetic device comprising:
a write element including a write element tip, wherein the write element is operable to generate a first field at the write element tip;
a conductor proximate the write element tip for carrying a current to generate a second field that augments the first field; and
an encapsulating layer on at least one surface of the conductor, wherein the encapsulating layer is made of a material that increases a maximum sustainable current density of the conductor to greater than about 10⁸ A/cm².

2. The magnetic device of claim 1, wherein the encapsulating layer is comprised of a material selected from the group consisting of Ru, Rh, TiW, Ta, NiFeCr, Cr, and combinations and alloys thereof.

3. The magnetic device of claim 1, wherein the conductor is comprised of Au and the encapsulating layer is comprised of a material selected from the group consisting of Ru, Rh, TiW, Ta, and combinations and alloys thereof.

4. The magnetic device of claim 1, wherein the conductor is comprised of Cu and the encapsulating layer is comprised of a material selected from the group consisting of Ta, NiFeCr, and combinations and alloys thereof.

5. The magnetic device of claim 1, wherein the conductor is comprised of Ag and the encapsulating layer is comprised of a material selected from the group consisting of Cr, Ta, Ru, and combinations and alloys thereof.

6. The magnetic device of claim 1, wherein the encapsulating layer is on multiple surfaces of the conductor.

7. The magnetic device of claim 6, wherein the encapsulating layer on one of the surfaces is comprised of different material than the encapsulating layer on another of the surfaces.

8. The magnetic device of claim 1, wherein the conductor comprises at least four surfaces.

9. The magnetic device of claim 1, wherein the conductor has a thickness of about 5 nm to about 1 μm and the encapsulating layer has a thickness from about 0.2 nm to about 100 nm.

10. The magnetic device of claim 1, wherein the conductor is proximate a trailing edge of the write element tip.

11. A magnetic writer comprising:
a write element that generates a write field at a front surface;
at least one return element magnetically coupled to the write element distal from the front surface;
a conductor proximate the front surface for carrying a current to generate an assist field that augments the write field; and
an encapsulating layer on at least one surface of the conductor, wherein the encapsulating layer is made of a material that increases a maximum sustainable current density of the conductor to greater than about 10⁸ A/cm².

12. The magnetic writer of claim 11, wherein the encapsulating layer is comprised of a material selected from the group consisting of Ru, Rh, TiW, Ta, NiFeCr, Cr, and combinations and alloys thereof.

13. The magnetic writer of claim 11, wherein the conductor is comprised of Au and the encapsulating layer is comprised of a material selected from the group consisting of Ru, Rh, TiW, Ta, and combinations and alloys thereof.

14. The magnetic writer of claim 11, wherein the conductor is comprised of Cu and the encapsulating layer is comprised of a material selected from the group consisting of Ta, NiFeCr, and combinations and alloys thereof.

15. The magnetic writer of claim 11, wherein the conductor is comprised of Ag and the encapsulating layer is comprised of a material selected from the group consisting of Cr, Ta, Ru, and combinations and alloys thereof.

16. The magnetic writer of claim 11, wherein the encapsulating layer is on multiple surfaces of the conductor.

17. The magnetic writer of claim 16, wherein the encapsulating layer on one of the surfaces is comprised of different material than the encapsulating layer on another of the surfaces.

18. The magnetic writer of claim 11, wherein the conductor comprises at least four surfaces.

19. The magnetic writer of claim 11, wherein the conductor has a thickness of about 5 nm to about 1 μm and the encapsulating layer has a thickness from about 0.2 nm to about 100 nm.

20. The magnetic writer of claim 11, wherein the conductor is proximate a trailing edge of the write element.

21. A magnetic field generating assembly comprising:
a conductor for carrying a current to generate a magnetic field; and
an encapsulating layer on at least one surface of the conductor, wherein the encapsulating layer is made of a material that increases a maximum sustainable current density of the conductor to greater than about 10⁸ A/cm² to provide a corresponding increase in the magnetic field generated by the conductor.

22. The magnetic field generating assembly of claim 21, wherein the conductor is comprised of Au and the encapsulating layer is comprised of a material selected from the group consisting of Ru, Rh, TiW, Ta, and combinations and alloys thereof.

23. The magnetic field generating assembly of claim 21, wherein the conductor is comprised of Cu and the encapsulating layer is comprised of a material selected from the group consisting of Ta, NiFeCr, and combinations and alloys thereof.

24. The magnetic field generating assembly of claim 21, wherein the conductor is comprised of Ag and the encapsulating layer is comprised of a material selected from the group consisting of Cr, Ta, Ru, and combinations and alloys thereof.
